(19) United States
(12) Patent Application Publication
(10) Pub. No.: US 2012/0244286 A1
(43) Pub. Date: Sep. 27, 2012

(54) PATTERN FORMING METHOD

(76) Inventor: Katsutoshi KOBAYASHI, Tokyo (JP)

(21) Appl. No.: 13/428,418

(22) Filed: Mar. 23, 2012

(30) Foreign Application Priority Data
Mar. 24, 2011 (JP) 2011-065280

(51) Int. Cl. B05D 5/00; B05D 3/00; B05D 3/12

(52) U.S. Cl. 427/277

(57) ABSTRACT

A pattern forming method includes the steps of: forming a pattern transfer layer on a process target film; bringing a mold into contact with the pattern transfer layer, the mold having a predetermined relief pattern on a surface thereof and including a porous layer formed on the surface and impregnated with a release agent; curing the pattern transfer layer in a state where the mold is in contact with the patter transfer layer; and releasing the mold from the pattern transfer layer. A low dielectric constant insulating film or amorphous carbon, for example, is used as the porous layer.

### BACKGROUND

In nanoimprint lithography, a mold (template) having a relief pattern to be transferred is prepared in advance. Then, the relief pattern on the mold is brought into contact with an imprint material formed on a process target film, the imprint material is photo-cured by UV irradiation, and then the mold is released. As a result, the pattern to be formed is transferred in the imprint material on a process target substrate.

There have heretofore been cases where friction occurring in the release of the mold and stress concentration due to deformation of the mold break the imprint material and thereby cause mold release defects. In order to prevent this, a method which subjects the mold to a mold release process has been used. However, a release layer formed by the mold release process on a surface of the template is peeled off as the imprint lithography is repeated, and therefore has a problem of causing mold release defects.

### BRIEF DESCRIPTION OF THE DRAWINGS

FIG. 1 is a cross-sectional view of a mold of an embodiment.

FIG. 2 is a schematic view showing how a porous layer on a surface of the mold is impregnated with a release agent.

FIG. 3 is a cross-sectional view showing a step of forming a predetermined pattern in a pattern transfer layer.

FIG. 4 is a cross-sectional view showing a step of forming the predetermined pattern in the pattern transfer layer.

FIG. 5 is a cross-sectional view showing a step of forming the predetermined pattern in the pattern transfer layer.

FIG. 6 is a cross-sectional view showing a step of forming the predetermined pattern in the pattern transfer layer.

### DETAILED DESCRIPTION

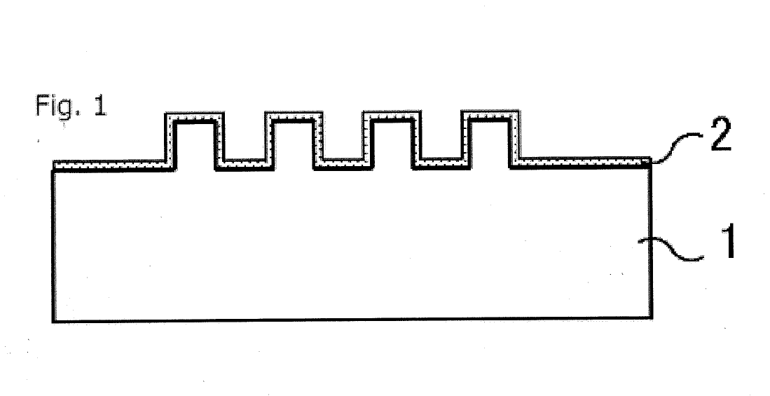

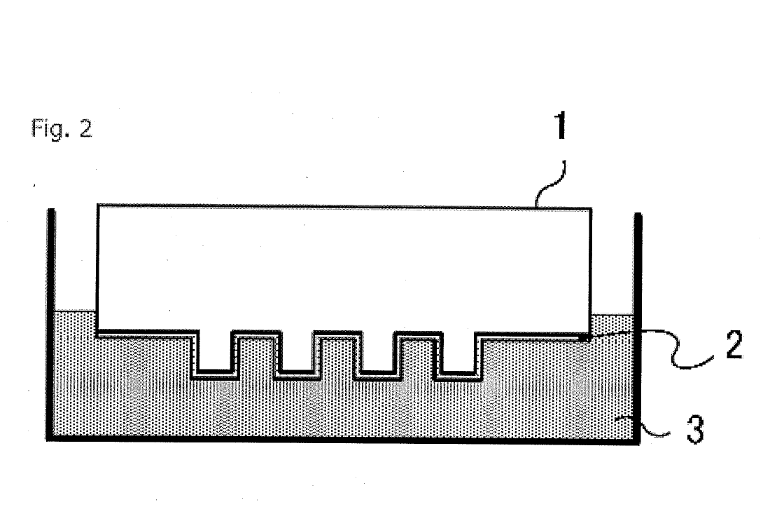

First, a mold of an embodiment will be described by referring to FIGS. 1 and 2.

FIG. 1 is a cross-sectional view of the mold of this embodiment. As shown in FIG. 1, a mold 1 formed of a quartz substrate, for example, has a predetermined relief pattern formed on a surface thereof. Further, a porous layer 2 is formed on the surface on which the relief pattern is formed. As the porous layer 2, a low dielectric constant insulating film such as a carbon-containing silicon oxide film (SiOC), or amorphous silicon is used. Forming the porous layer on the mold surface facilitates impregnation of the mold with a release agent and thereby allows an improvement in the mold releasability in the mold release. Details will be described later.

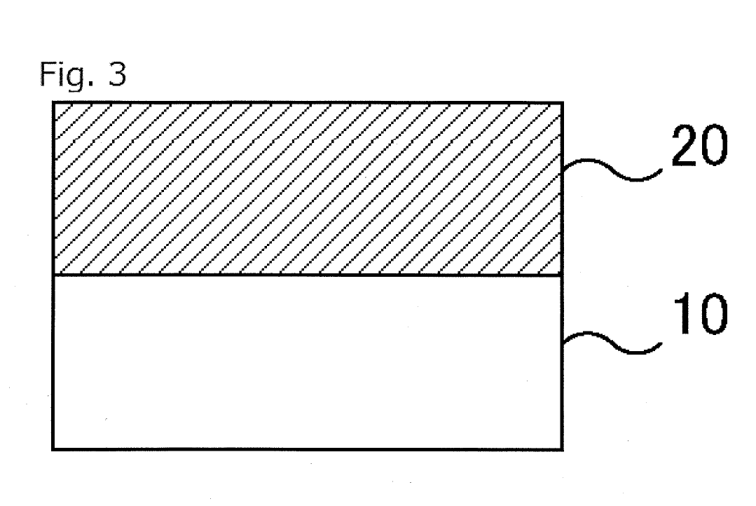

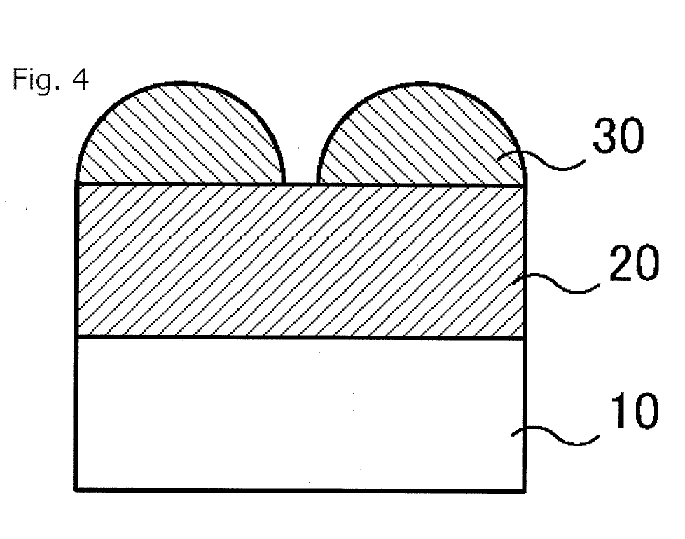

FIG. 2 is a schematic view showing how the porous layer on the mold surface is impregnated. As shown in FIG. 2, the porous layer 2 on the mold 1 is impregnated with a release agent 3 after mold release is performed a predetermined number of times. The release agent 3 is a silane coupling agent, for example. As will be described layer, providing the porous layer 2 on the surface of the mold 1 facilitates the impregnation of the mold 1 with the release agent 3. Next, a pattern forming method according to this embodiment will be described by referring to FIGS. 3 to 6. FIGS. 3 to 6 are cross-sectional views showing steps of forming a predetermined pattern in a pattern transfer layer on a semiconductor substrate.

First, as shown in FIG. 3, a process target film 20 is formed on a semiconductor substrate 10. The process target film 20 is a silicon oxide film (SiO₂), for example, and is formed with a film thickness of 2000 A on the semiconductor substrate.

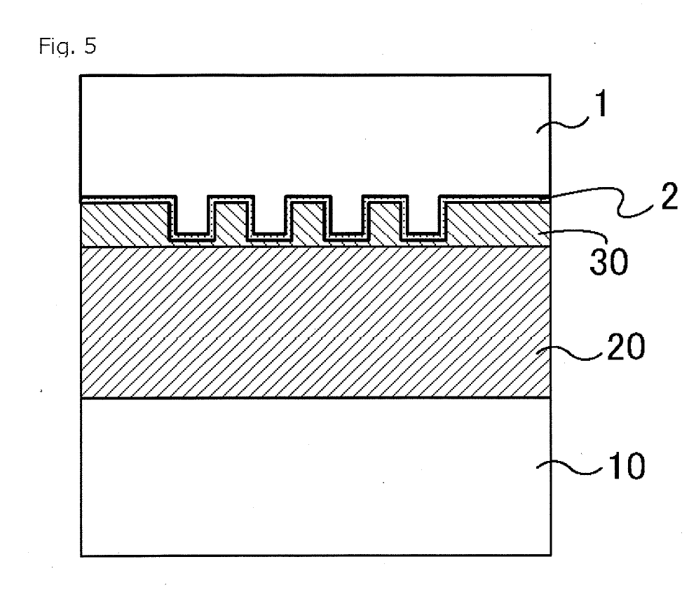

Then, as shown in FIG. 4, a pattern transfer layer 30 is formed on the process target film 20. The pattern transfer layer 30 is a photo-curable resin dripped by use of an ink-jet method, for example.

Then, as shown in FIG. 5, the mold 1 shown in FIGS. 1 and 2, which has the predetermined relief pattern on the surface thereof and includes the porous layer 2 formed on the surface and impregnated with the release agent 3, is brought into contact with the pattern transfer layer 30 on the process target film 20 and is held in this state for a certain period of time. This allows the pattern transfer layer 30 to be filled in the recessed portions on the surface of the mold 1 and therefore gives a predetermined pattern in the pattern transfer layer 30. Then, the mold 1 is irradiated with ultraviolet rays from the side opposite to the surface on which the relief pattern is formed, so that the pattern transfer layer 30 is cured.

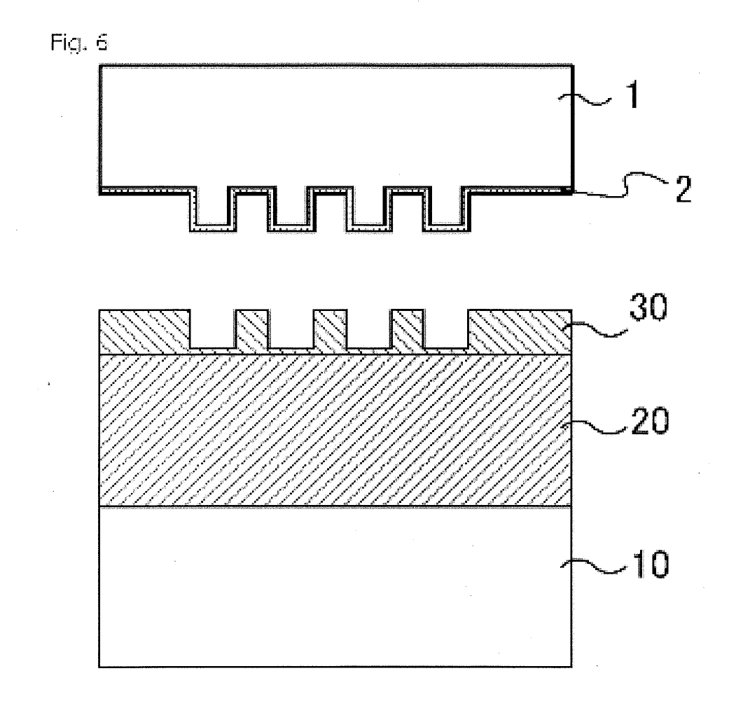

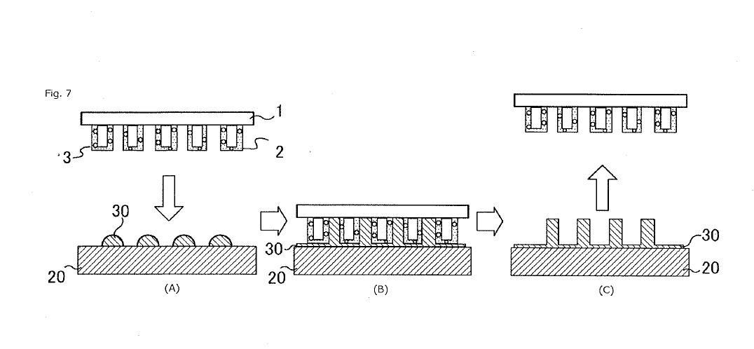

Then, as shown in FIG. 6, the mold 1 is released from the pattern transfer layer 30. After the mold release, patterns are formed in the process target film through a well-known etching process and other well-known processes.

Next, advantages of the pattern forming in this embodiment using the mold having the porous layer on the surface thereof will be described by referring to FIGS. 7A to 7C. FIGS. 7A to 7C are schematic views showing some steps in the pattern forming.

As shown in FIG. 7A, the porous layer 2 on the surface of the mold 1 is impregnated with the release agent 3 (see FIG. 2). Then, as the mold 1 in this state is brought into contact with the pattern transfer layer 30 on the process target film 20 as shown in FIG. 7B, the release agent 3 with which the porous layer 2 on the surface of the mold 1 is impregnated oozes. This facilitates the release of the mold 1 from the pattern transfer layer 30. Then, as shown in FIG. 7C, the mold 1 is released. Since the release agent 3 oozes, the generation of mold release defects in the mold release can be suppressed. Meanwhile, the porous layer 2 after the mold release is still impregnated with part of the release agent 3. Thus, the contacting and releasing steps can be repeated a predetermined number of times by using the remaining release agent 3. Then, after the contacting and releasing are performed the predetermined number of times, the porous layer on the mold is again impregnated with the release agent, as shown in FIG. 2.

As mentioned earlier, as the porous layer 2, a low dielectric constant insulating film such as a carbon-containing silicon oxide film (SiOC), or amorphous silicon is used. Moreover, as the low dielectric constant insulating film, SiON may be used, for example. The porous material has large interatomic distances, and the bonded atoms have large spaces therebetween accordingly. Thus, the porous material is well impregnated with the release agent.

By performing pattern forming with the mold having the porous layer on the surface thereof and being impregnated with the release agent as described above, it is possible to suppress the generation of mold release defects in the pattern forming using nanoimprint lithography.

1. A pattern forming method comprising the steps of:
forming a pattern transfer layer on a process target film;
bringing a mold into contact with the pattern transfer layer, the mold having a predetermined relief pattern on a surface thereof and including a porous layer formed on the surface and impregnated with a release agent;
curing the pattern transfer layer in a state where the mold is in contact with the patter transfer layer; and
releasing the mold from the pattern transfer layer.

2. The pattern forming method according to claim 1, wherein a low dielectric constant insulating film is used as the porous layer.

3. The pattern forming method according to claim 1, wherein amorphous carbon is used as the porous layer.

4. The pattern forming method according to claim 1, wherein a silane coupling agent is used as the release agent.

5. The pattern forming method according to claim 1, wherein the porous layer on the mold is impregnated with the release agent after the mold release is performed a predetermined number of times.
